(19) United States
(12) Patent Application Publication
(10) Pub. No.: US 2010/0218640 A1
(43) Pub. Date: Sep. 2, 2010

(54) DETACHABLE BRAKE LEVER ASSEMBLY FOR A BICYCLE

(76) Inventor: Chester Wen, Chang Hua Hsien (TW)

Correspondence Address: Chien-Hui Su, P. O. Box 70-121 Taichung, Taichung City, 40899, TW

(21) Appl. No.: 12/703,784

(22) Filed: Feb. 11, 2010

(30) Foreign Application Priority Data
Feb. 27, 2009 (TW) 098203017

(51) Int. Cl. B62L 3/02; B62K 23/06

(52) U.S. Cl. 74/523

(57) ABSTRACT

A detachable brake lever assembly for a bicycle includes a brake seat connected to a handlebar of a bicycle. The brake seat has an engaging portion formed thereon and extending therefrom. The engaging portion is formed into a shape of an equilateral polygon. A holder is connected to the brake seat. The holder has an engaging recess defined therein and corresponding to the shape of the engaging portion for engaging with the engaging portion. A pull lever is rotatably connected to the holder; wherein the engaging portion is able to engage with the engaging recess in different positions corresponding to the shape of the equilateral polygon. The brake lever which is assembled with the holder is adjusted with the holder relative to the brake seat for appropriately cooperating with different types of bicycle handlebars.

### BACKGROUND OF THE INVENTION

1. Field of the Invention

The present invention relates to a detachable brake lever assembly for a bicycle, and more particularly to a brake lever assembly for a bicycle which is adjustable and detachable for appropriately cooperating with a handlebar of a bicycle.

2. Description of Related Art

A conventional brake operating device for bicycles in accordance with the prior art comprises a brake lever rotatably which is installed through a pivot on a housing mounted on a flat type handlebar. An operating wire is interlockingly connected to the brake lever through a wire connector, and a force transmission ratio adjusting means for adjusting a force transmission ratio by moving the wire connecter toward and away from the pivot in accordance with the operation of the brake lever. In this device, the force transmission ratio adjusting means comprises a long hole which is provided in the brake lever and guides the wire connector in relation to the pivot, and a link pivotally which is installed at one end to the wire connector installed in the long hole and is also pivotally supported at the other end on the housing through the other pivot than the pivot stated above.

However, the conventional brake operating device for bicycles can be only mounted on the flat type handlebar, because the brake lever is designed to be mounted on the housing in a fixed position. Therefore, it is inconvenient to apply the brake operating device on different types of the handlebars. And the braking operating device which is assembled with a right handlebar should be different from the device which is assembled with a left handlebar. So it is not economical to manufacture two brake operating device which are respectively applied on the left and right handlebars.

The present invention has arisen to mitigate and/or obviate the disadvantages of the conventional brake operating device for bicycles.

### SUMMARY OF THE INVENTION

The main objective of the present invention is to provide an improved brake lever assembly for a bicycle.

To achieve the objective, the detachable brake lever assembly for a bicycle in accordance with the present invention includes a brake seat which adapts to be connected to a handlebar of a bicycle. The brake seat has a connecting portion formed on one end thereof for adapting to be mounted to the handlebar. The brake seat has an engaging portion formed on one end thereof and extending therefrom. The engaging portion is located opposite to the connecting portion. The engaging portion is formed into a shape of an equilateral polygon.

The engaging portion of the brake seat has at least three protrusions which are formed and equally spaced on an outer lateral periphery thereof The engaging portion has at least three indent portions which are formed and equally spaced on the outer lateral periphery thereof Each indent portion is located between any two adjacent protrusions. The engaging portion has at least one first threaded hole axially defined therein.

A holder is coaxially connected to the brake seat. The holder has an engaging recess defined in one end thereof The engaging recess corresponds to the shape of the engaging portion of the brake seat for detachably engaging with the engaging portion.

The holder has at least three notches which are defined and equally spaced in an inner periphery of the engaging recess and are located corresponding to the at least three protrusions, such that any of the at least three protrusions is engageably connected to any of the at least three notches. The holder has at least three blocking portions which are formed on the inner periphery of the engaging recess and are located corresponding to the at least three indent portions. Each blocking portion is located between any two adjacent notches, such that any of the at least three indent portions is engageably connected to any of the at least three blocking portions.

The holder has at least one second threaded hole axially defined in the engaging recess. Each second threaded hole is located corresponding to each first threaded hole. At least one screw correspondingly passes through the at least one second threaded hole and the at least one first threaded hole for screwedly connecting the holder with the brake seat.

A pull lever is rotatably connected to one end of the holder which is opposite to the engaging recess.

Therefore, the engaging portion of the brake seat is able to engage with the engaging recess of the holder in different positions which correspond to the shape of the equilateral polygon. The brake lever which is assembled with the holder is adjusted with the holder relative to the brake seat for adapting to appropriately cooperate with different types of bicycle handlebars.

Further benefits and advantages of the present invention will become apparent after a careful reading of the detailed description with appropriate reference to the accompanying drawings.

### BRIEF DESCRIPTION OF THE DRAWINGS

FIG. 1 is an exploded perspective view of a detachable brake lever assembly for a bicycle in accordance with the present invention;

FIG. 2 is a perspective view of an engaging portion of a brake seat of the detachable brake lever assembly for a bicycle in accordance with the present invention;

FIG. 3 is an assembled perspective view of the detachable brake lever assembly for a bicycle in accordance with the present invention;

FIG. 4 is a cross-sectional top view of the detachable brake lever assembly for a bicycle in accordance with the present invention;

FIG. 5 is a perspective view of the detachable brake lever assembly for a bicycle in accordance with the present invention as the brake lever assembly is mounted on a flat type handlebar; and

FIG. 6 is a perspective view of the detachable brake lever assembly for a bicycle in accordance with the present invention as the brake lever assembly is mounted on a drop type handlebar.

### DETAILED DESCRIPTION OF THE INVENTION

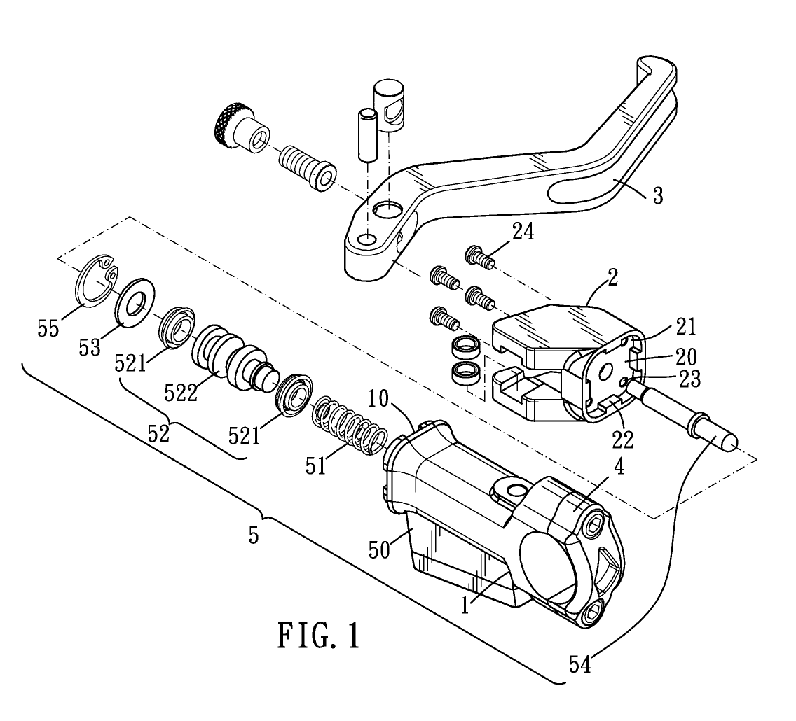

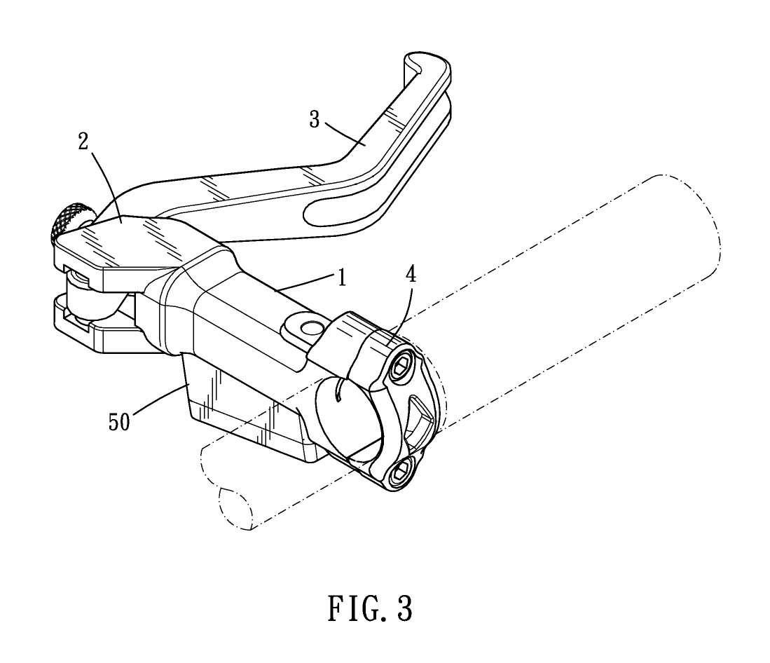

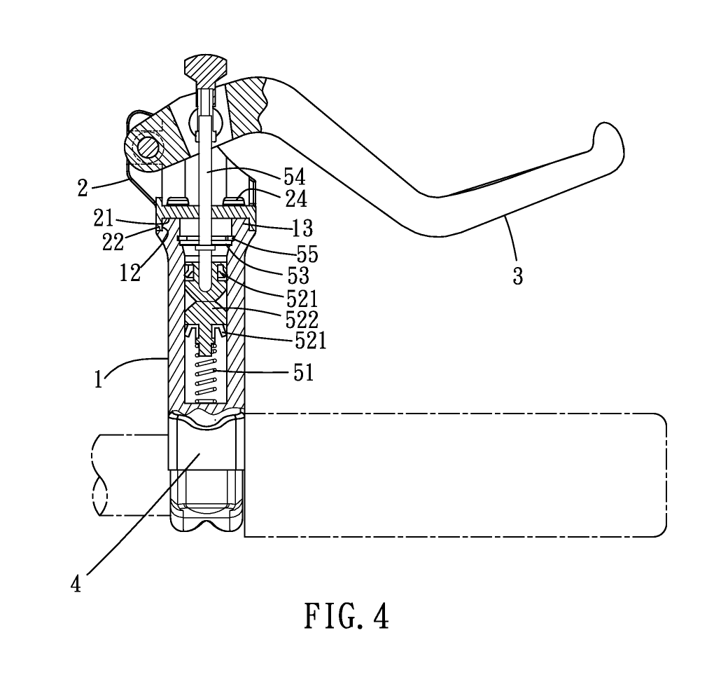

Referring to the drawings and initially to FIGS. 1-4, a detachable brake lever assembly for a bicycle in accordance with the present invention comprises a brake seat 1 which has a connecting portion 4 formed on one end thereof for adapting to be mounted to a handlebar of a bicycle. The brake seat 1 has an engaging portion 10 axially formed on the other end thereof and extending therefrom. The engaging portion 10 is located opposite to the connecting portion 4 and formed into a shape of an equilateral polygon.

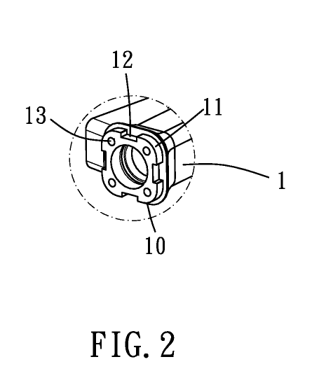

In a preferred embodiment, as shown in FIG. 2, the engaging portion 10 is an equilateral quadrangle. The engaging portion 10 has four protrusions 11 which are formed and equally spaced on an outer lateral periphery thereof The four protrusions 11 are respectively located at four corners of the engaging portion 10. The engaging portion 10 has four indent portions 12 which are formed and equally spaced on the outer lateral periphery thereof Each indent portion 12 is located between any two adjacent protrusions 11. Four first threaded holes 13 are axially defined in a top of the engaging portion 10. The four first threaded holes 13 are respectively located in the four protrusions 11.

A holder 2 is coaxially connected to the brake seat 1. The holder 2 has an engaging recess 20 axially defined in one end thereof The engaging recess 20 corresponds to the shape of the engaging portion 10 for detachably engaging with the engaging portion 10 of the brake seat 1. The holder 2 has four notches 21 which are defined and equally spaced in an inner lateral periphery of the engaging recess 20. The four notches 21 are located corresponding to the four protrusions 11 of the engaging portion 10, such that any of the four protrusions 11 is engageably connected to any of the four notches 21.

The holder 2 has four blocking portions 22 which are formed and equally spaced on the inner lateral periphery of the engaging recess 20. Each blocking portion 22 is located between any two adjacent notches 21. The four blocking portions 22 are located corresponding to the four indent portions 12 of the engaging portion 10, such that any of the four indent portions 12 is engageably connected to any of the four blocking portions 22. Four second threaded holes 23 are axially defined in a bottom of the engaging recess 20. Each second threaded hole 23 is located corresponding to each first threaded hole 13.

Four screws 24 respectively pass through the four second threaded holes 23 in the holder 2 and the four first threaded holes 13 in the engaging portion 10 of the brake seat 1 for screwedly connecting the holder 2 with the brake seat 1.

A pull lever 3 is rotatably connected to one end of the holder 2 and is located opposite to the engaging recess 20.

Furthermore, a hydraulic mechanism 5 is movably mounted between the pull lever 3 and the brake seat 1. The hydraulic mechanism 5 has an oil tank 50 disposed on the brake seat 1 for providing oil or other lubricants. The hydraulic mechanism 5 includes an elastomer 51, a piston assembly 52, a washer 53 and a C-shaped ring 55 coaxially orderly received in the brake seat 1. The piston assembly 52 includes a piston 522 and two seals 521 which are respectively disposed on two end of the piston 522. The two seals 521 can prevent oil or other lubricants from leaking out of the piston assembly 52. The elastomer 51 is compressible and has two ends respectively abutting against the brake seat 1 and one of the two seals 521.

A pressing rod 54 axially passes through the washer 53, the C-shaped ring 55, and the holder 2 to be movably mounted between the pull lever 3 and the brake seat 1. The pressing rod 54 has two ends which respectively abut against the piston assembly 52 and the pull lever 3 for being simultaneously moved by a movement of the pull lever 3. The C-shaped ring 55 is located between the holder 3 and the washer 53 for retaining the pressing rod 54 in place.

Therefore, the four protrusions 11 respectively engage with the four notches 21 and the four indent portions 12 respectively engage with the four blocking portions 22, such that the holder 2 wouldn't be rotated relative to the brake seat 1 by the movement of the pull lever 3. And the holder 2 is easily quickly detached or assembled from the brake seat 1 by loosening or fastening the four screws 24.

Moreover, the engaging portion 10 of the brake seat 1 is able to engage with the engaging recess 20 of the holder 2 in four positions which correspond to the shape of the equilateral quadrangle. The brake lever 3 which is assembled with the holder 2 is adjusted with the holder 2 relative to the brake seat 1 for appropriately cooperating with different types of bicycle handlebars. Accordingly, the detachable brake lever assembly for a bicycle is able to be assembled with a left handlebar or a right handlebar by adjusting an engagement of the holder 2 and the brake seat 1.

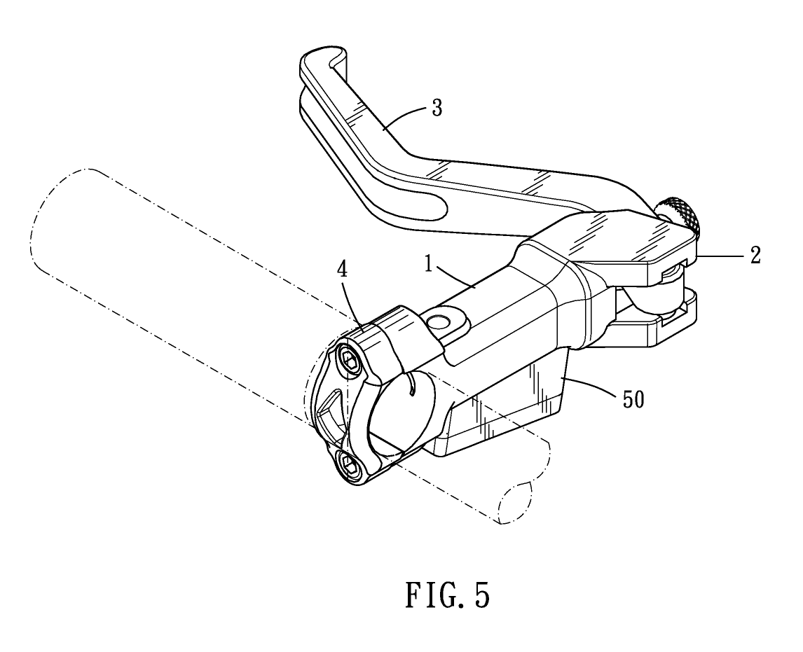

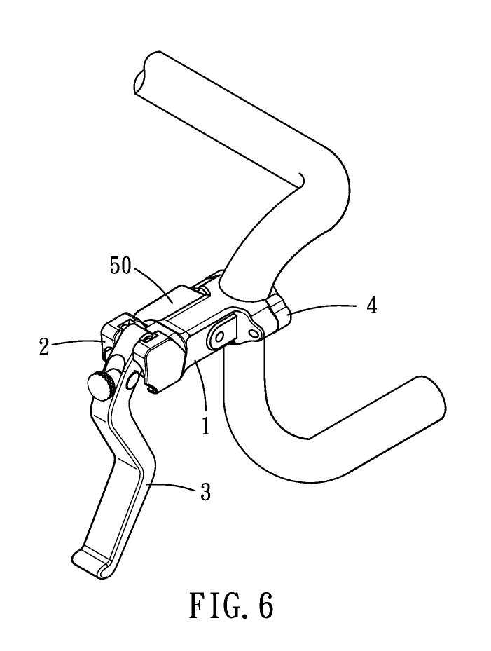

Referring to FIG. 5, the brake seat 1 is mounted on a flat type handlebar (not numbered). The holder 2 is adjusted to engage with the brake seat 1, wherein the pull lever 3 assembled with the holder 2 is in a position which is appropriate to cooperate with the flat type handlebar. Continuing to refer to FIG. 6, the brake seat 1 is mounted on a drop type handlebar (not numbered). The holder 2 is adjusted to engage with the brake seat 1, wherein the pull lever 3 assembled with the holder 2 is in a position which is appropriate to cooperate with the drop type handlebar.

Although the invention has been explained in relation to its preferred embodiment, it is to be understood that many other possible modifications and variations can be made without departing from the spirit and scope of the invention as hereinafter claimed.

What is claimed is:

1. A detachable brake lever assembly for a bicycle comprising:
a brake seat adapting to be connected to a handlebar of a bicycle, the brake seat having an engaging portion formed on one end thereof and extending therefrom, the engaging portion formed into a shape of an equilateral polygon;
a holder coaxially connected to the brake seat, the holder having an engaging recess defined in one end thereof, the engaging recess corresponding to the shape of the engaging portion of the brake seat for detachably engaging with the engaging portion; and
a pull lever rotatably connected to one end of the holder and positioned opposite to the engaging recess;
wherein the engaging portion of the brake seat is able to engage with the engaging recess of the holder in different positions corresponding to the shape of the equilateral polygon, the pull lever assembled with the holder being adjustable relative to the brake seat for adapting to appropriately cooperate with different types of bicycle handlebars.

2. The detachable brake lever assembly for a bicycle as claimed in claim 1, wherein the engaging portion of the brake seat has at least three protrusions formed on an outer lateral periphery thereof, the holder having at least three notches defined in an inner periphery of the engaging recess and located corresponding to the at least three protrusions, such that any of the at least three protrusions is engageably connected to any of the at least three notches.

3. The detachable brake lever assembly for a bicycle as claimed in claim 2, wherein the engaging portion of the brake seat has at least three indent portions formed and equally spaced on the outer lateral periphery thereof, each indent portion located between any two adjacent protrusions, the holder having at least three blocking portions formed on the inner periphery of the engaging recess and located corresponding to the at least three the indent portions, each blocking portion located between any two adjacent notches, such that any of the at least three indent portions is engageably connected to any of the at least three blocking portions.

4. The detachable brake lever assembly for a bicycle as claimed in claim 2, wherein the engaging portion has at least one first threaded hole axially defined therein, the holder having at least one second threaded hole axially defined in the engaging recess, each first threaded hole located corresponding to each second threaded hole, at least one screw correspondingly passing through the at least one second threaded hole and correspondingly screwed into the at least one first threaded hole for connecting the holder with the brake seat.

5. The detachable brake lever assembly for a bicycle as claimed in claim 1, wherein the brake seat has a connecting portion formed on one end thereof and located opposite to the engaging portion for adapting to be mounted to the handlebar.
